(19) United States
(12) Patent Application Publication
(10) Pub. No.: US 2020/0221041 A1
(43) Pub. Date: Jul. 9, 2020

(54) MULTI-LENS PARALLAX CAMERA SYSTEM

(71) Applicant: IVS, INC., dba ANGELTRAX, DOTHAN, AL (US)

(72) Inventor: RICHIE HOWARD, NEWTON, AL (US)

(21) Appl. No.: 16/239,883

(22) Filed: Jan. 4, 2019

(51) Int. Cl. H04N 5/341; H04N 5/225; H04N 5/232; G06T 7/00

(52) U.S. Cl. CPC H04N 5/3415; H04N 5/2259; B60R 2300/8006; G06T 7/97; B60R 2300/105; H04N 5/23238

(57) ABSTRACT

A multi-lens parallax camera system includes a bracket which includes a first plane, a second plane, and a third plane; wherein the first and the second planes respectively have a first opening and a second opening, and the third plane is interposed between the first and the second planes and symmetrically connects the first and the second planes. The multi-lens parallax camera system further includes a first camera and a second camera which are symmetrically and respectively mounted in and protruded from the first opening and the second opening. The first and the second cameras both have a first angle of view and generate a first image and a second image, respectively, the part of the first image and the second image having parallax forms an overlapping area; and a processor seamlessly stitches the first and the second images together to form a seamless wide-angle image.

### BACKGROUND OF THE INVENTION

### 1. Field of the Invention

The present invention relates to a parallax camera system, and particularly to a multi-lens parallax camera system applied for use in the interior of buses for surveillance purposes. Surveillance recordings are common in passenger buses to assist in training bus operators, investigating complaints, and accident investigations.

### 2. Description of the Related Art

The current use of wide-angle cameras and/or fisheye cameras allows for wider field of view (FOV) in video cameras inside or outside mobile vehicles and fixed locations. A wider field of view allows a single camera to receive a wider image which may allow the use of fewer cameras to cover a bus interior. Cameras with wide angle lenses are typically those that provide a wider field of view than the human eye. When taken to an extreme these cameras produce a “fisheye” effect with distortions particularly at the periphery of the image. This distortion may render face recognition or movements by people or objects difficult or impossible to identify. Many mobile or vehicle applications of wide-angle cameras are based upon cameras that initially were introduced for interior and exterior surveillance services inside or outside buildings and fixed facilities built with high ceilings. In addition, a single surveillance wide angle camera, commonly called a 360 degree camera, in a limited space with a low ceiling like the interior of a bus, etc. will sometimes fail to monitor events, because, a standing person may block the view of an incident, and in addition, 360 degree video cameras in surveillance service also contain audio microphones and a single microphone position often proves inadequate for an incident investigation due to lack of proximity to the received sounds since a single microphone can't resolve the relative directions between audio sources and the microphone.

When it comes to capturing interior images of a vehicle such as a bus, using the wide-angle non-fisheye camera remains a possible choice because it is capable of capturing images with a larger FOV with excellent Depth of Field (DOF) in such a limited space with low ceiling.

In general, for fixed sensor size (full frame, APS-C, and so on) and fixed focal length, the FOV (diagonal, horizontal or vertical) of a wide angle camera is larger than the FOV in an ordinary camera, and the larger the ratio between the two FOVs is, the more distorted the captured images are, especially at periphery.

### SUMMARY OF THE INVENTION

In view of the above-mentioned limitations of the conventional wide angle “fisheye” cameras, an objective of the present invention is to ameliorate the image distortion problems caused by the conventional wide-angle or fisheye cameras.

Accordingly, the present invention proposes a multi-lens parallax camera system to solve these limitations by utilizing multiple standard non-fisheye lens cameras to reduce the required angle of view for each camera so as to minimize the image distortion thereof. The present invention also proposes using an image processing method to stitch together the images captured by each one of the multiple cameras to come up with a seamless wide image such that the parallax issue in the overlapped portion of the captured images is simultaneously resolved. The present invention also proposes deploying a plurality of the multi-lens parallax camera systems of the present invention at symmetrical positions to fully cover a limited space such as the interior of a bus and the like, so as to minimize the potential possibility of failing to capture certain incidences. Each strategically mounted parallax camera contains at least two microphones solving the audio proximity problem and eliminates the fisheye distortion of the recorded images. This prevents the distorted video images from the wide angle fisheye cameras. Because each multi-lens parallax camera has a minimum of a 180 degree field of view, it is virtually impossible for standing passengers to block the recording of an event. And, because there are no fisheye lenses incorporated in the parallax cameras, there is no distortion and all faces, events, and actions are recognizable.

One of the aforesaid objectives can be achieved by the multi-lens parallax camera system which is described as follows:

A multi-lens parallax camera system includes:

a housing;

a bracket enclosed by the housing and including:
a first plane having a first opening;
a second plane having a second opening; and
a third plane interposed between the first plane and the second plane and symmetrically connecting the first plane and the second plane;

a first camera enclosed by the housing; and

a second camera enclosed by the housing;

wherein the first camera and the second camera are symmetrically and respectively mounted in and protruded from the first opening and the second opening.

Another one of the aforesaid objectives can be achieved by the multi-lens parallax camera system which is described as follows:

A method for mounting multi-lens parallax camera systems, wherein N multi-lens parallax camera systems as described above are respectively mounted on N geometrically symmetric positions in a periphery of a monitored space to avoid dead angles or inadvertent blocking by objects while monitoring, where N is an integer greater than or equal to 2.

### BRIEF DESCRIPTION OF THE DRAWINGS

FIG. 1A shows a schematic of an internal structure of a multi-lens parallax camera system of the present invention;

FIG. 1B shows a schematic of a bracket structure of the multi-lens parallax camera system of the present invention;

FIG. 1C shows a cross-section of a bracket structure of the multi-lens parallax camera system of the present invention;

FIG. 2A shows a schematic of the appearance of the multi-lens parallax camera system and the angle of view of a first camera of the present invention;

FIG. 2B shows a schematic of the appearance of the multi-lens parallax camera system and the angle of view of a second camera of the present invention;

FIG. 2C shows a schematic of a combined viewing angle and circuits of the multi-lens parallax camera system of the present invention;

FIG. 3A shows examples of a first image and a second image before the stitching;

FIG. 3B shows examples of the first image and the second image during the progress of the stitching;

FIG. 3C shows examples of the first image and the second image after the stitching;

FIG. 4 shows a segmented LED light source of the multi-lens parallax camera system of the present invention;

FIG. 5 shows the multi-lens parallax camera system of the present invention using two microphones;

FIG. 6 shows the disposition diagram of two multi-lens parallax camera systems of the present invention; and

FIG. 7 shows the disposition diagram of four multi-lens parallax camera systems of the present invention.

### DETAILED DESCRIPTION OF THE INVENTION

These and other aspects of the embodiments herein will be better appreciated and understood when considered in conjunction with the following description and the accompanying drawings.

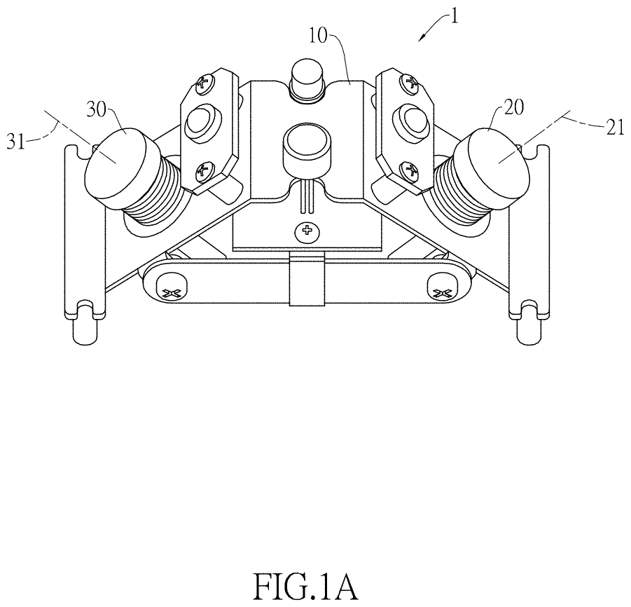

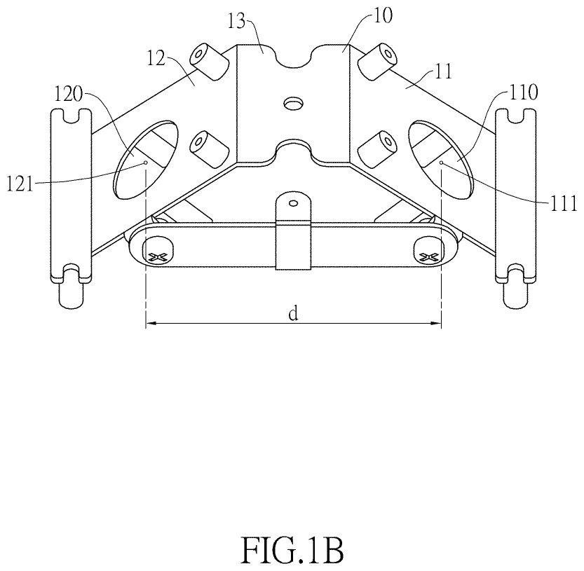

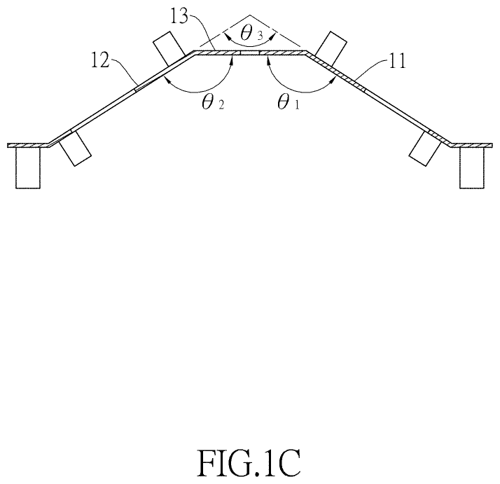

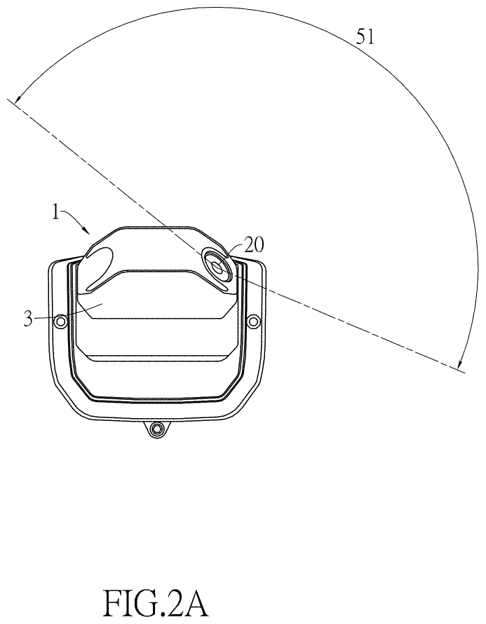

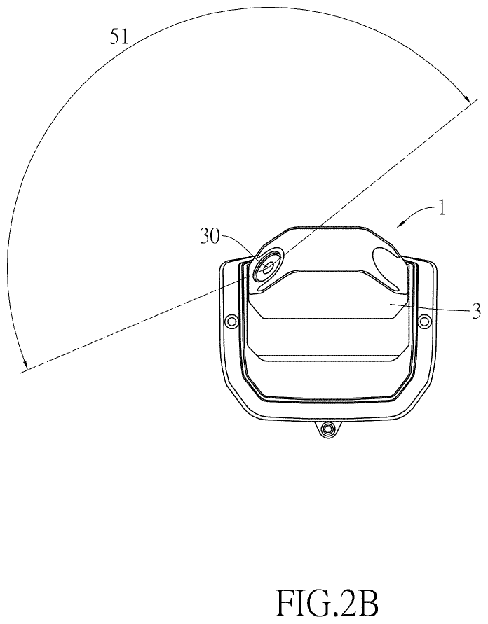

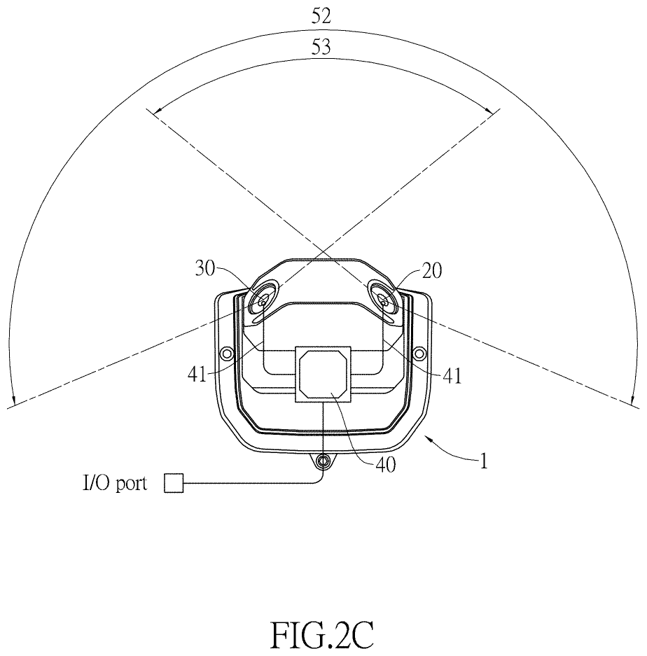

With reference to FIGS. 1A, 1B, according to a first embodiment of the present invention, a multi-lens parallax camera system 1 includes a housing 3 (not shown in FIGS. 1A, 1B, see FIGS. 2A, 2B, 2C), a bracket 10, a first camera 20, and a second camera 30. The first camera 20 and the second camera 30 are symmetrically mounted on the bracket 10. The bracket 10 includes a first plane 11 and a second plane 12. The first plane 11 and the second plane 12 respectively have a first opening 110 and a second opening 120, wherein the first opening 110 and the second opening 120 respectively have a first opening center 111 and a second opening center 121, wherein the first opening center 111 is the geometric center of the first opening 110. For example, when the first opening 110 is circular, the first opening center 111 is the center of the circle, and likewise, the second opening center 121 is the geometric center of the second opening 120. There is a first distance d between the first opening center 111 and the second opening center 121. The bracket 10 includes a third plane 13 interposed between the first plane 11 and the second plane 12 and symmetrically connected to the first plane 11 and the second plane 12. With reference to FIG. 1C, a cross-section of the bracket 10 is demonstrated to indicate that the third plane 13 and the first plane 11 form a first angle θ1, the third plane 13 and the second plane 12 form a second angle θ2, and the extensions of the first plane 11 and the second plane 12 form a third angle θ3, wherein the first angle θ1 and the second angle θ2 are equal in ordinary cases. With reference to FIG. 1B, the first camera 20 and the second camera 30 are, respectively and symmetrically, fixed and protruded from the first opening 110 and the second opening 120. The first camera 20 and the second camera 30 respectively have a first optical axis 21 and a second optical axis 22. The first optical axis 21 and the second optical axis 22 are respectively perpendicular to the first plane 11 and the second plane 12, and also pass through the first opening center 111 and the second opening center 121. The bracket 10, the first plane 11, the second plane 12, and the third plane 13 are made of metallic materials such as steel, copper, aluminum, metal alloy or plastic materials such as Polyvinyl Chloride (PVC), acrylic, Polycarbonates (PC), or a combination thereof. The first camera 20 and the second camera 30 are identical digital cameras each with a lens.

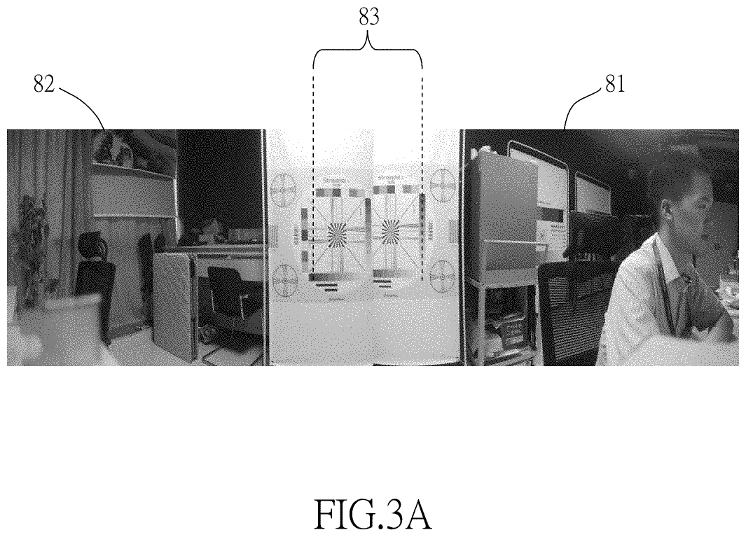

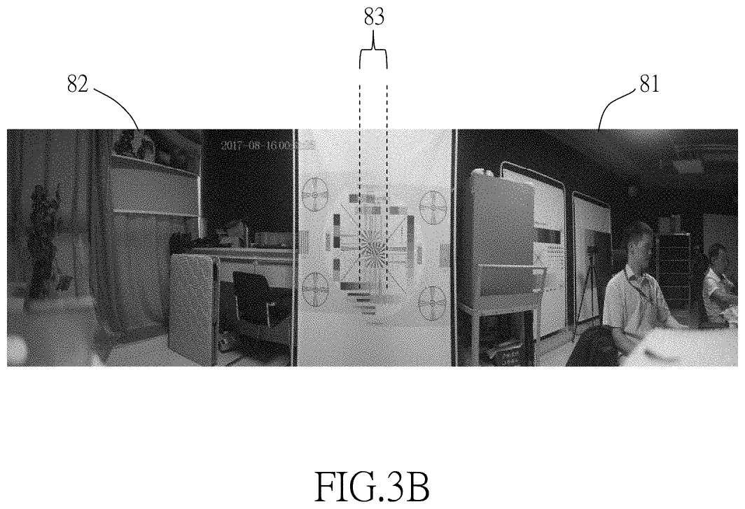

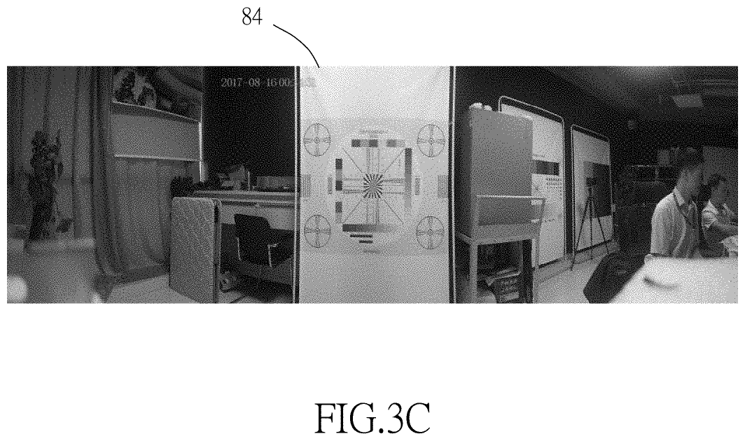

With reference to FIGS. 2A, 2B, 2C, the multi-lens parallax camera system 1 is equipped with a housing 3, the housing 3 enclosing the bracket 10, and the first and the second cameras 20, 30. The first camera 20 and the second camera 30 have an identical first angle of view 51. Under the first angle of view 51, the first camera 20 and the second camera 30 can respectively generate a first image 81 and a second image 82 (not shown in FIGS. 2A, 2B, 2C, see FIG. 3A). The first image 81 and the second image 82 have an image overlapping area 83 (not shown in FIG. 2, see FIG. 3A), and in the image overlapping area 83, there exists a phenomenon of parallax which indicates that if an image of an object is located in the image overlapping area 83, then the images of the same object captured respectively by the first camera 20 and the second camera 30 are different from each other due to different perspectives. The multi-lens parallax camera system 1 further includes a processor 40 such as a general CPU, a microcontroller, a digital signal processor, an image processor, or a combination thereof, and the processor 40 is electrically connected to the first camera 20 and the second camera 30 via signal lines 41, and thereby the processor 40 is to respectively receive the information of the first image 81 and the second image 82 from the first camera 20 and the second camera 30.

With reference to FIGS. 3A, 3B, 3C, after receiving the information of the first image 81 and the second image 82, the processor 40 integrates the first image 81 and the second image 82 into a seamless wide-angle image 84 by an imaging processing algorithm FIGS. 3A, 3B, 3C demonstrate the stitching from beginning to the end; afterwards the wide viewing angle image 84 is further processed and encoded into a general digital image format file such as GIF, JPEG, MPEG, etc., and then output, for playback or storage, via an I/O port to a display device such as an LCD and the like, or a memory device such as SRAM, DRAM, or FLASH MEMORY and the like. The above-mentioned imaging processing algorithm is, for example, a cylindrical projection splicing algorithm, which firstly projects the first image 81 and the second image 82 onto a cylindrical surface, and then fuses the overlapping area 83 of the first image 81 and the second image 82 on the surface of the cylinder to produce the seamless wide viewing angle image 84.

With reference to FIG. 2C again, the seamless image 84, generated by the integration of the first image 81 and the second image 82, has a combined viewing angle 52, for example, assuming the first angle of view 51 is 104° and the combined viewing angle 52 is 189°. Then, it can be inferred that the two cameras have an overlapping viewing angle 53 which is corresponding to the image overlapping area 83. Hence, the overlapping viewing angle 53 is equal to the sum of the individual wide viewing angles 51 of the two wide-angle cameras minus the combined viewing angle 52, i.e. 104°+104°−189°=19°, hence the overlapping viewing angle 53 of the first camera 20 and the second camera 30 is 19°.

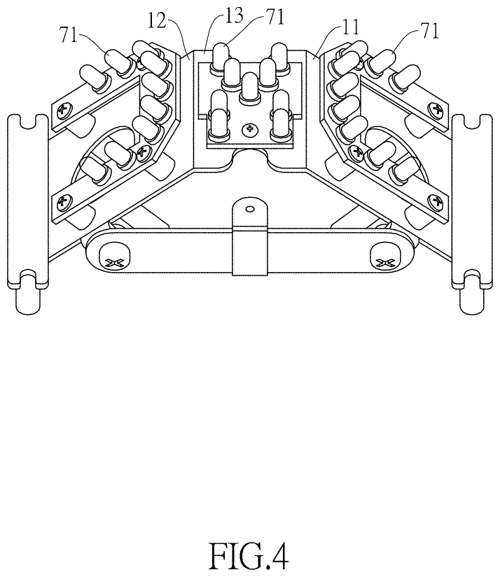

With reference to FIG. 4, according to a second embodiment of the present invention, the multi-lens parallax camera system 1 is equipped with a light source such as a light-emitting diode (LED) light source 71, which can emit visible light, infrared light, ultraviolet light, or a combination thereof, for taking pictures in nighttime or dim situations, and this embodiment also adopts a segmented disposition of the LED light sources 71 in such a way that the LEDs of the LED light source 71 are respectively disposed on the first plane 11, the second plane 12, and the third plane 13 to make the brightness of illumination evenly distributed. And the housing 3 of the multi-lens parallax camera system 1 is designed accordingly to be transparent to allow the light from the LED light sources 71 to pass through.

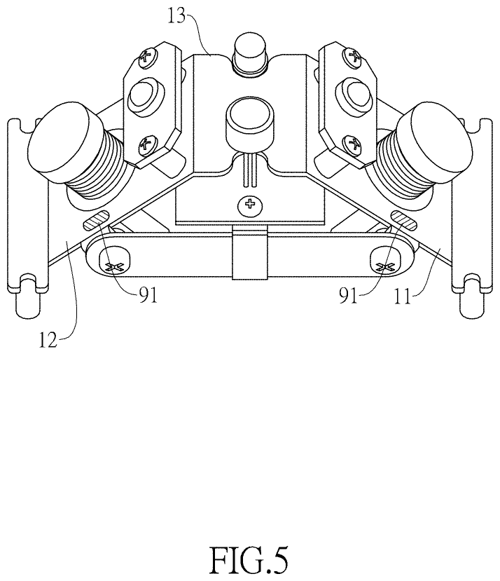

With reference to FIG. 5, according to a third embodiment of the present invention, the multi-lens parallax camera system 1 is provided with two microphones 91 corresponding to the two cameras, respectively, and sounds from two different directions can be obtained via the two microphones 91. For example, the two microphones 91 are respectively disposed on the first plane 11 and the second plane 12 corresponding to the locations of the first camera 20 and the second camera 30, so that the two microphones 91 can receive the sounds from two different directions. The audio analog signals of the sounds received by the two microphones 91 are respectively converted into digital signals by ADC circuits and then transmitted to the processor 40. After receiving the digital signals of the sounds, the processor 40 can perform further signal processing on the received audio signals and encode the processed results into a general digital audio format such as MIDI, WAV, MP3, etc. for playback or storage.

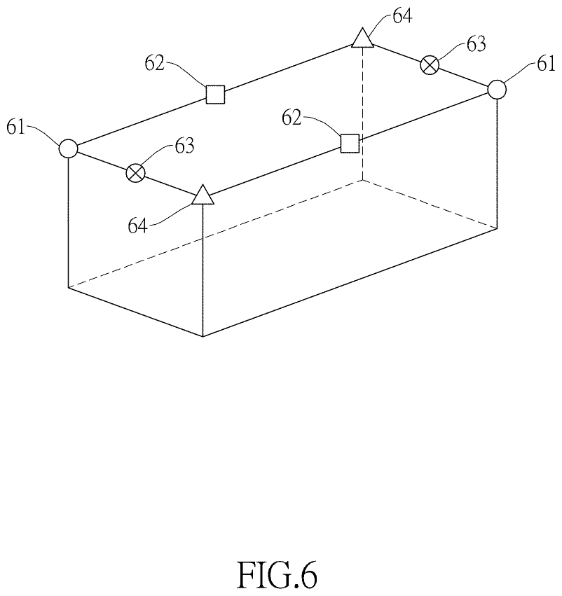

With reference to FIG. 6, according to a fourth embodiment of the present invention, two independent multi-lens parallax camera systems 1 are respectively mounted at opposite positions on the periphery of a limited space, so that the two independent multi-lens parallax camera systems 1 are less likely to be constantly or inadvertently blocked by objects in the limited space; thus the two independent multi-lens parallax camera systems 1 are more reliable in monitoring incidences happening in the limited space. For example, the above two independent multi-lens parallax camera systems 1 can be disposed at the symmetry positions such as 61, 62, 63 or 64 in FIG. 6.

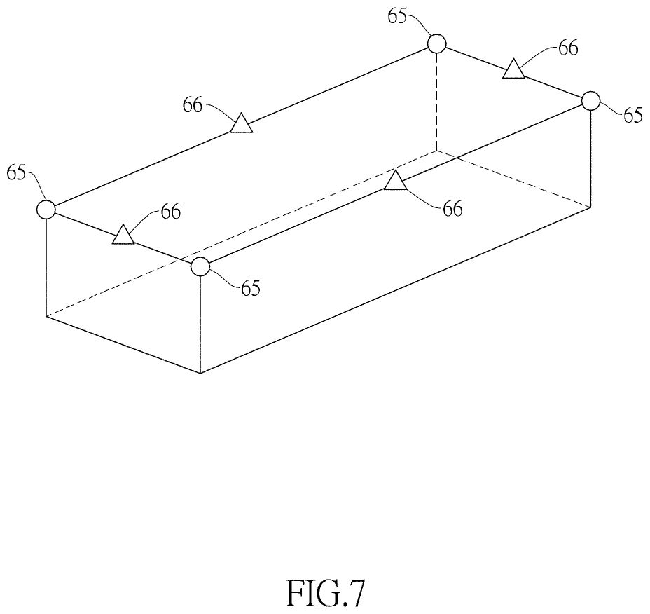

With reference to FIG. 7, according to a fifth embodiment of the present invention, four independent multi-lens parallax camera systems 1 are provided, which are respectively disposed at four symmetric positions on the periphery of a limited space, so that the four independent multi-lens parallax camera systems 1 are less likely to be constantly or inadvertently blocked by objects in the limited space; thus the four independent multi-lens parallax camera systems 1 are more reliable in monitoring incidences happening in the limited space. For example, the above four independent multi-lens parallax camera systems 1 can be disposed at the symmetric positions such as 65 or 66 in FIG. 7.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A multi-lens parallax camera system including:
a housing;
a bracket enclosed by the housing and including:
a first plane having a first opening;
a second plane having a second opening; and
a third plane interposed between the first plane and the second plane and symmetrically connecting the first plane and the second plane;
a first camera enclosed by the housing; and
a second camera enclosed by the housing;
wherein the first camera and the second camera are symmetrically and respectively mounted in and protruded from the first opening and the second opening.

2. The multi-lens parallax camera system as claimed in claim 1, wherein the first opening and the second opening respectively have a first opening center and a second opening center, the first opening center and the second opening center are respectively the geometric center of the first opening and the geometric center of the second opening, the first camera and the second camera respectively have a first optical axis and a second optical axis, the first optical axis and the second optical axis are respectively perpendicular to the first plane and the second plane, and the first optical axis and the second optical axis respectively pass through the geometric center of the first opening and the geometric center of the second opening.

3. The multi-lens parallax camera system as claimed in claim 1, wherein the bracket, the first plane, the second plane, and the third plane are made of metallic materials, plastic materials or a combination thereof.

4. The multi-lens parallax camera system as claimed in claim 1, wherein the first camera and the second camera both have a first angle of view; the first camera and the second camera respectively generate a first image and a second image, and the part of the first image and the second image having parallax forms an overlapping area.

5. The multi-lens parallax camera system as claimed in claim 4, wherein the multi-lens parallax camera system further includes an image processing software executed by a processor to seamlessly stitch the first image and the second image together to form and output a seamless wide-angle image.

6. The multi-lens parallax camera system as claimed in claim 1, wherein the bracket further includes a segmented light source which has a multitude of light emitting diodes disposed on the first plane, the second plane, and the third plane to provide illumination with evenly distributed brightness.

7. The multi-lens parallax camera system as claimed in claim 1, wherein the bracket further includes two microphones, and the two microphones, respectively corresponding to the first camera and the second camera, and are disposed on the first plane and the second plane to receive sounds from two different directions.

8. A method for mounting multi-lens parallax camera systems, wherein N multi-lens parallax camera systems as claimed in claim 1 are respectively disposed on N geometrically symmetric positions in a periphery of a monitored space to avoid dead angles or inadvertent blocking by objects while monitoring, where N is an integer greater than or equal to 2.

9. The method for mounting multi-lens parallax camera systems as claimed in claim 8, wherein the first opening and the second opening respectively have a first opening center and a second opening center, the first opening center and the second opening center are respectively the geometric center of the first opening and the geometric center of the second opening, the first camera and the second camera respectively have a first optical axis and a second optical axis, the first optical axis and the second optical axis are respectively perpendicular to the first plane and the second plane, and the first optical axis and the second optical axis respectively pass through the geometric center of the first opening and the geometric center of the second opening.

10. The method for mounting multi-lens parallax camera systems as claimed in claim 8, wherein the bracket, the first plane, the second plane, and the third plane are made of metallic materials, plastic materials or a combination thereof.

11. The method for mounting multi-lens parallax camera systems as claimed in claim 8, wherein the first camera and the second camera both have a first angle of view; the first camera and the second camera respectively generate a first image and a second image, and the part of the first image and the second image having parallax forms an overlapping area.

12. The method for mounting multi-lens parallax camera systems as claimed in claim 11, wherein each multi-lens parallax camera system further includes an image processing software executed by a processor to seamlessly stitch the first image and the second image together to form and output a seamless wide-angle image.

13. The method for mounting multi-lens parallax camera systems as claimed in claim 8, wherein the bracket further includes a segmented light source which has multiple light emitting diodes disposed on the first plane, the second plane, and the third plane to provide illumination with evenly distributed brightness.

14. The method for mounting multi-lens parallax camera systems as claimed in claim 8, wherein the bracket further includes two microphones, and the two microphones, respectively corresponding to the first camera and the second camera, are mounted on the first plane and the second plane to receive sounds from two different directions.
